(19) United States
(12) Patent Application Publication
(10) Pub. No.: US 2002/0054626 A1
(43) Pub. Date: May 9, 2002

(54) Data transmitting and receiving apparatus for performing radio communication from terminal apparatus having operation section to transmitting and receiving processing section provided for machine body

(75) Inventor: Junichi Inamura, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/982,613

(22) Filed: Oct. 18, 2001

(30) Foreign Application Priority Data
Oct. 20, 2000 (JP) 2000-320728

(51) Int. Cl. H04L 5/16; H04B 1/38

(52) U.S. Cl. 375/219

(57) ABSTRACT

A transmitting and receiving processing section sequentially sends data which includes a communication command to each controller. When each controller receives the data, it sends back data which includes an operation signal to the transmitting and receiving processing section. During a period when the transmitting and receiving processing section communicates with a machine body, the transmitting and receiving processing section sends a dummy signal. When a controller receives the dummy signal, it does not send back an operation signal, but operates so as to set a receiving mode for the next time slot. Therefore, even during a busy period when the transmitting and receiving processing section is busy, data transmission and receiving is performed between the transmitting and receiving processing section and each controller. Since each controller is made to enter a short receiving mode during the busy period, the power consumption of the controller is reduced.

### BACKGROUND OF THE INVENTION

1. Field of the Invention

The present invention relates to data transmitting and receiving apparatuses for performing radio communication from a terminal apparatus having an operation section to a transmitting and receiving processing section provided for a machine body or to a transmitting and receiving processing section connected to the machine body, for example, for a game use.

2. Description of the Related Art

In a transmitting and receiving apparatus used for games, for example, a terminal apparatus called a controller performs operations by radio, such as by an electromagnetic wave or by an infrared ray. In such an apparatus, a game-machine body is connected to a TV receiver, and a transmitting and receiving processing section is built into the game-machine body, or the transmitting and receiving processing section is connected to the game-machine body as an external unit. Between the controller and the transmitting and receiving processing section, mutual communication is performed by radio.

In the apparatus, when the controller receives a communication command from the transmitting and receiving processing section, the controller sends back an operation signal to the transmitting and receiving processing section. Then, the transmitting and receiving processing section sends data to a processing section of the game-machine body during a period when no communication with the controller is made, so that the game-machine body can perform processing operations.

One transmitting and receiving processing section may be provided with a plurality of controllers. In this case, communication is made in a time-divisional manner between the transmitting and receiving processing section and the plurality of controllers.

FIG. 5 is a timing chart showing conventional communication timing between one transmitting and receiving processing section and a plurality of terminal apparatuses, and between the transmitting and receiving processing section and a game-machine body.

A first row of the timing chart shown in FIG. 5 indicates data transmitting and receiving timing in the transmitting and receiving processing section. Subsequent rows indicate data transmitting and receiving timing in each controller. In this case, four controllers are used and they are called CT1, CT2, CT3, and CT4.

A time T1 during which the transmitting and receiving processing section communicates with one controller is called one time slot. At the start of each time slot, the transmitting and receiving processing section sends data D1, D2, D3, or D4, each having an ID code of a respective controller, and a communication command to CT1, CT2, CT3, or CT4. The controllers are set to receiving modes R1, R2, R3, and R4, respectively, at the start of each of the time slots or at times slightly earlier. The receiving modes continue until the data having the communication command is received.

When the terminal control sections of the controllers determine that they have received the communication command, they send operation signals D1a, D2a, D3a, and D4a generated according to operations at the operation sections of the controllers to the transmitting and receiving processing section.

A period in which the above-described processing is applied to each of the controllers CT1 to CT4 is called one frame. This frame is repeated twice (F1 and F2). After these two frames, the transmitting and receiving processing section communicates with the game-machine body to send data generated according to the operation signals sent from the controllers to the game-machine body.

Since the control section (CPU) of the transmitting and receiving processing section is occupied in the above-described communication period when the transmitting and receiving processing section sends the data to the game-machine body, communication processing between the transmitting and receiving processing section and the controllers may be prevented.

When data communication between the transmitting and receiving processing section and the game-machine body takes a long period, timing may be shifted in data communication between the transmitting and receiving processing section and the controllers.

To avoid such a situation, when the control section of the transmitting and receiving processing section is occupied due to communication between the transmitting and receiving processing section and the game-machine body, the controllers continue receiving waiting states R1a, R2a, R3a, and R4a in the order of CT1, CT2, CT3, and CT4, respectively, as shown in FIG. 5. When the occupied state of the control section of the transmitting and receiving processing section is released, and the transmitting and receiving processing section sends the regular data D1, D2, D3, or D4, including a communication command, the controllers release the receiving waiting states R1a, R2a, R3a, or R4a when they receive the data. Immediately thereafter, the controllers send data D1a, D2a, D3a, or D4a to the transmitting and receiving processing section. Since the receiving waiting states R1a, R2a, R3a, and R4a continue, the regular data D1, D2, D3, and D4 is received successfully.

However, as shown in FIG. 5, when the control section of the transmitting and receiving processing section is occupied, and if the controllers CT1, CT2, CT3, and CT4 continue the receiving waiting states R1a, R2a, R3a, and R4a for long periods, the control sections of the controllers experience increased control loads and reduced battery life.

The same condition occurs even if the transmitting and receiving processing section is provided with one controller. The controller needs to have a long receiving waiting state during communication performed between the transmitting and receiving processing section and the game-machine body. Thus, there is a problem that the life of battery of the controller is reduced.

### SUMMARY OF THE INVENTION

Accordingly, it is an object of the present invention to provide a data transmitting and receiving apparatus which reduces the receiving waiting state at a terminal apparatus, set when the control section of a transmitting and receiving processing section is occupied, to reduce the load of the control section of the terminal apparatus, and which also reduces the consumption of electric power.

The foregoing object is achieved by the present invention through the provision of a data transmitting and receiving apparatus including a terminal apparatus having an operation section, and a transmitting and receiving processing section for receiving an operation signal sent from the terminal apparatus by radio and for sending data to a host section. The transmitting and receiving processing section includes a control section for sending a dummy signal to the terminal apparatus at an interval having a predetermined time during a busy period when processing for sending data to the host section is performed, and for sending a communication command to the terminal apparatus at the interval in a period other than the busy period. The terminal apparatus includes a receiving section for which a receiving mode is set for a period shorter than the interval in each interval, and a terminal control section for sending an operation signal to the transmitting and receiving processing section when the communication command is received in the receiving mode, and for controlling so as not to send the operation signal when the dummy signal is received in the receiving mode.

The data transmitting and receiving apparatus may be configured such that the transmitting and receiving processing section is provided with N (N is an integer equal to two or more). The control section of the transmitting and receiving processing section performs control such that it sequentially sends the communication command to each terminal apparatus at the interval during a period other than the busy period. It also sends a dummy signal at the interval, and then sequentially sends a communication command after the dummy signal is sent, during the busy period.

The data transmitting and receiving apparatus may be configured such that a receiving mode is sequentially set for each terminal for a period shorter than the interval in each interval. When each terminal receives the communication command in the receiving mode, it sends the operation signal to the transmitting and receiving processing section, and when each terminal receives the dummy signal or data sent to another terminal in the receiving mode, it does not send an operation signal to the transmitting and receiving processing section, but operates so as to set the receiving mode in the next interval.

The data transmitting and receiving apparatus may be configured such that, when the busy period has n intervals (n is an integer equal to one or more), the transmitting and receiving processing section issues a dummy signal n times in n intervals, and thereafter, sequentially sends the communication command to each terminal apparatus.

The data transmitting and receiving apparatus may be configured such that, when one frame referes to a period in which the communication command is sequentially sent to a first terminal apparatus to an N-th terminal apparatus, the control section of the transmitting and receiving processing section has one frame or more between the busy period and the next busy period.

The data transmitting and receiving apparatus may be configured such that, when one frame refers to a period in which the communication command is sequentially sent to a first terminal apparatus to an N-th terminal apparatus, the transmitting and receiving processing section has the busy period inserted into the frame.

As described above, and according to the present invention, in data transmission and receiving performed between the transmitting and receiving processing section and the terminal apparatus, the transmitting and receiving processing section sends a dummy signal to the terminal apparatus during the busy period in which the transmitting and receiving processing section sends data to the host section, and when the terminal apparatus receives the dummy signal, the terminal apparatus does not send an operation signal to the transmitting and receiving processing section. Therefore, mutual communication is always performed between the transmitting and receiving processing section and the terminal apparatus, and an operation can be thereby confirmed. In addition, there is no need to set a receiving waiting state unnecessarily long at the terminal apparatus. Consequently, the control section of the terminal apparatus has a reduced load, and power consumption is thus reduced.

### BRIEF DESCRIPTION OF THE DRAWINGS

FIG. 1 is a perspective view of the entire structure of a data transmitting and receiving apparatus according to an embodiment of the present invention.

FIG. 2A is a block diagram of the structure of a transmitting and receiving processing section, and FIG. 2B is a block diagram of the structure of each controller.

FIG. 3 is a timing chart of data transmission and receiving between each controller and the transmitting and receiving processing section.

FIG. 4 is another timing chart of data transmission and receiving between each controller and the transmitting and receiving processing section.

FIG. 5 is a timing chart of conventional data transmission and receiving between each controller and a transmitting and receiving processing section.

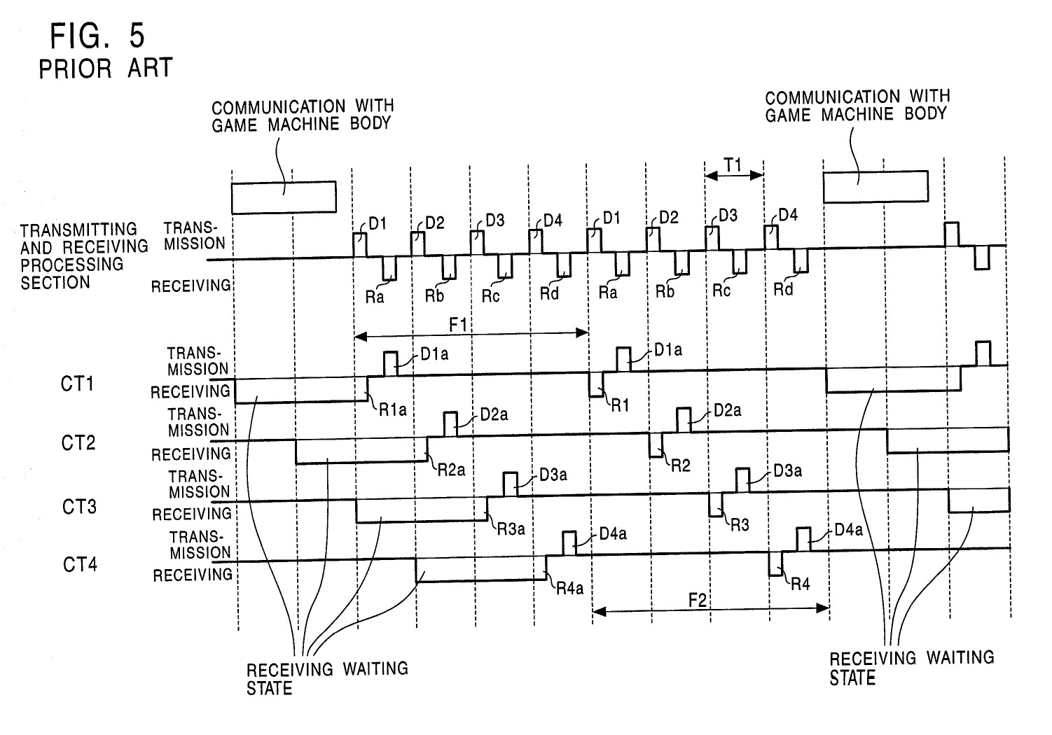

### DESCRIPTION OF THE PREFERRED EMBODIMENT

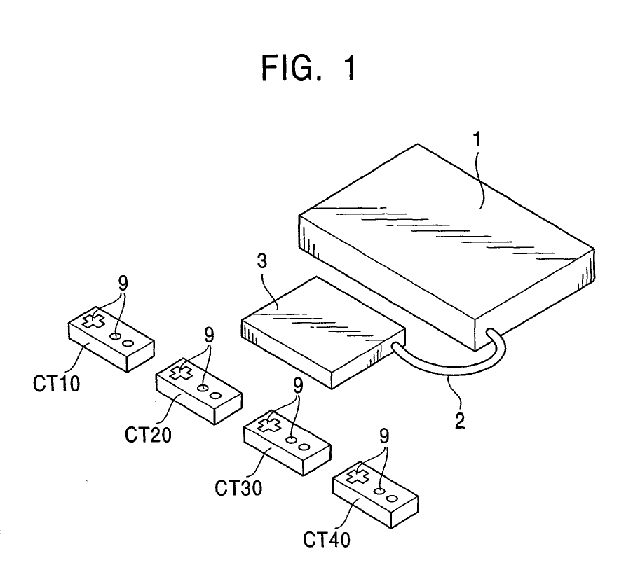

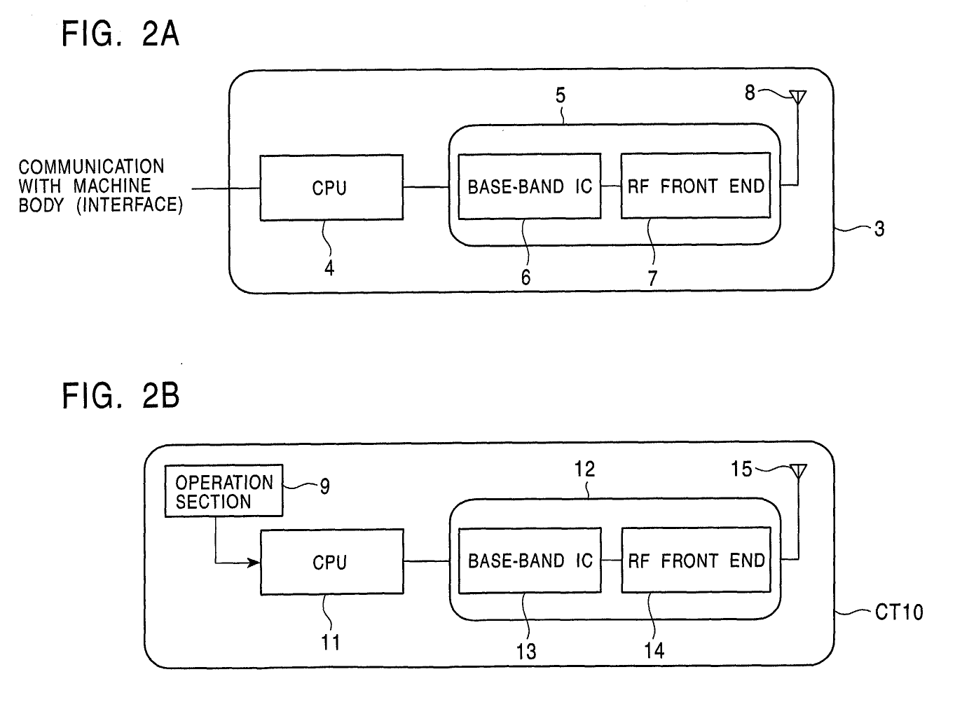

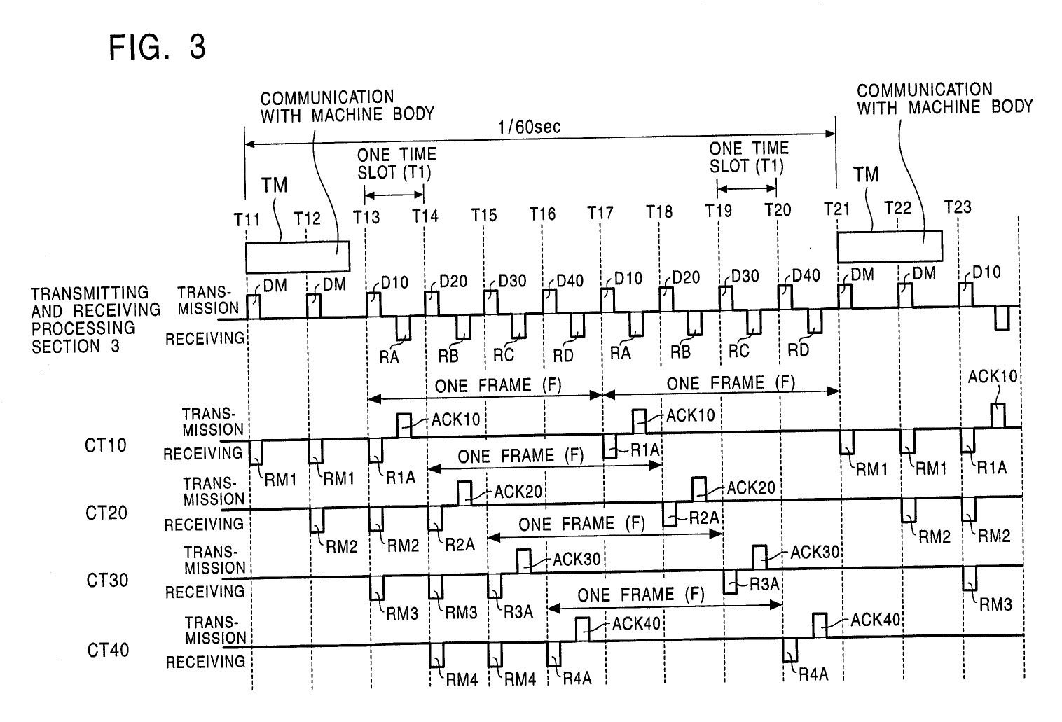

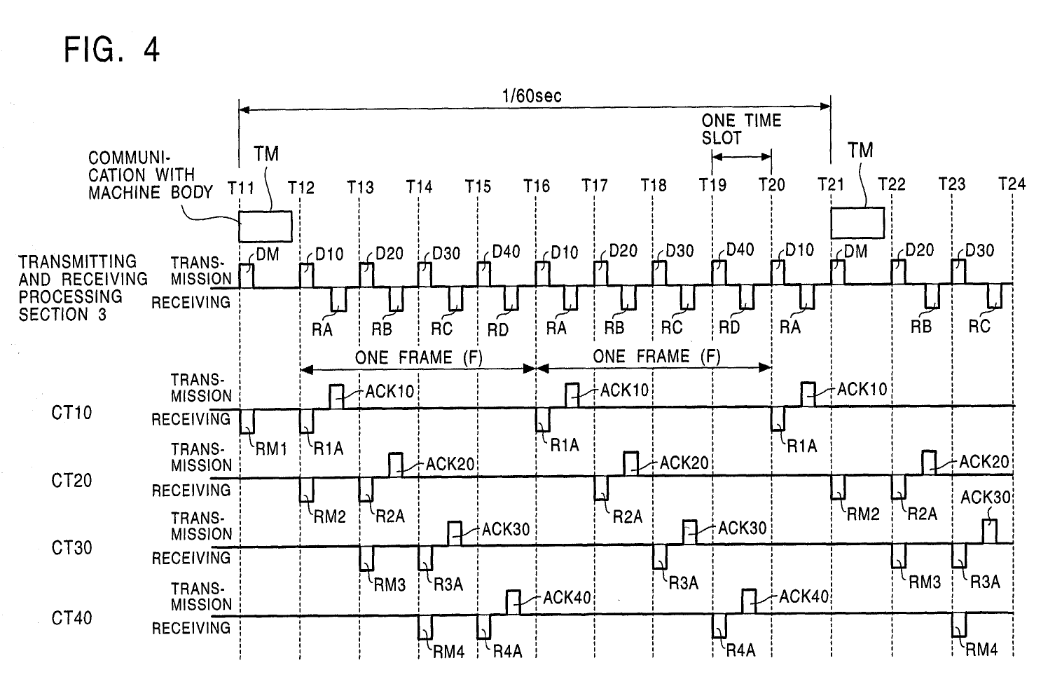

FIG. 1 is a perspective view showing the entire structure of a data transmitting and receiving apparatus as utilized for games, according to an embodiment of the present invention. FIGS. 2A and 2B are circuit block diagrams of main sections of the data transmitting and receiving apparatus. FIGS. 3 and 4 are data transmission and receiving timing charts.

Referring to FIG. 1, a game-machine body 1, serving as a host section in the present invention, is connected to a display section such as a TV receiver by a cable (not shown), and accommodates a reading apparatus for reading data from a recording medium such as a CD-ROM. The game-machine body 1 also includes a processing section for performing video and audio processing in which a game program downloaded from the recording medium is executed and a video signal and an audio signal are sent to the TV receiver according to the execution of the program.

The machine body 1 (host section) is connected to a transmitting and receiving processing section 3, serving as an external unit, by a cable 2. A plurality of controllers serving as terminal apparatuses are provided. In the present embodiment shown in the figure, a total of four controllers CT10, CT20, CT30, and CT40 are used. Each controller includes an operation section 9 having a plurality of pushbuttons or controls. Each controller also includes an internal power supply that includes a battery or a dry cell, which supplies electric power to the controller to perform radio (RF) receiving and transmission with the transmitting and receiving processing section 3.

The machine body 1 may be, for example, a personal computer. In addition, the transmitting and receiving processing section 3 may be built into the machine body 1.

As shown in FIG. 2A, the transmitting and receiving processing section 3 is formed of a CPU 4 that primarily serves as a main control section, and an RF module 5 that serves as a data transmitting and receiving section. The CPU 4 is connected to the machine body 1 through a predetermined interface. The RF module 5 comprises a base-band IC 6 and an RF front-end 7. The base-band IC 6 includes an oscillator, and modulates a carrier generated by the oscillator with transmission data generated by the CPU 4 during transmission. A modulated wave is converted to a predetermined-frequency signal by the RF front end 7 and is transmitted by an antenna 8. During receiving, a signal received by the antenna 8 is tuned, amplified, converted to an intermediate-frequency signal, and sent to the base-band IC 6 by the RF front end 7. The base-band IC 6 demodulates the intermediate-frequency signal to obtain data that is then sent to the CPU 4.

As shown in FIG. 2B, each of the controllers CT10, CT20, CT30, and CT40, serving as terminal apparatuses, is provided with a CPU 11 that serves as a terminal control section for monitoring the operation state of the operation section 9, and an RF module 12. The RF module 12 comprises a base-band IC 13 and an RF front end 14. Each controller sends an operation signal, which corresponds to an operation performed at the operation section 9, from an antenna 15. Each controller also receives data, sent from the transmitting and receiving processing section 3, through the antenna 15, and then demodulates the data and sends it to the CPU 11.

In FIG. 3, the first row indicates transmission and receiving timing at the transmitting and receiving processing section 3, and subsequent rows indicate transmission and receiving timing for the controllers CT10, CT20, CT30, and CT40, respectively.

(Operation of the Transmitting and Receiving Processing Section)

As shown in FIG. 3, the CPU 4, serving as the main control section of the transmitting and receiving processing section 3, sets one time slot T1 (for example, 1/600 seconds), and operates so as to send data at the start of each time slot for a period shorter than a single time slot T1.

When the CPU 4 is not busy processing data, the CPU 4 sequentially sends data D10, D20, D30, and D40, each including an individual ID code and a communication command, to the controllers CT10, CT20, CT30, and CT40 in that order. In other words, the CPU 4 sequentially sends data (including the ID code of the controller) and a communication command to a first controller CT10, then to a second controller CT20, then to a third controller CT30, and then to a fourth controller CT40. Data is transmitted at the start of each time slot (i.e., T13, T14, T15, etc.). Each data transmission period is shorter than one time slot (T1).

After the transmitting and receiving processing section 3 sends each of the data D10, D20, D30, and D40, it sets receiving modes RA, RB, RC, and RD within the time slots.

A set of four time slots in which the data D10 is transmitted and the receiving mode RA is set, the data D20 is transmitted and the receiving mode RB is set, the data D30 is transmitted and the receiving mode RC is set, and the data D40 is transmitted and the receiving mode RD is set, is called one frame (F), and the frame is repeated twice. Alternatively, the number of frames may be one, or three or more.

The CPU 4, serving as the main control section, sends data to the machine body 1, serving as the host section, through an interface every 1/60 seconds. In FIG. 3, this communication period with the machine body 1 is indicated as TM. In FIG. 3, the communication period TM with the machine body 1 extends into two time slots. In the communication period TM with the machine body 1, the transmitting and receiving processing section 3 sends data generated according to an operation signal sent from each controller to the machine body 1.

In the two time slots where a communication period TM with the machine body 1 is disposed, the CPU 4 is busy processing data. Since the CPU 4 has a heavy load while applying receiving processing to the data sent from each controller, dummy signals DM are sent in these two time slots. A dummy signal is sent for a short period (shorter than the time slot T1) at the start of each time slot where the communication period TM is disposed.

(Operation of Each Controller (Terminal Apparatus))

The CPU (terminal control section) 11 of each of the controllers CT10, CT20, CT30, and CT40 communicates with the transmitting and receiving processing section 3 when the power is turned on to perform initialization in order to synchronize with processing operations in the transmitting and receiving processing section 3.

Receiving modes RM1, RM2, RM3, and RM4, and receiving modes R1A, R2A, R3A, and R4A, are set in the time slots in the order of the first controller CT10, the second controller CT20, the third controller CT30, and the fourth controller CT40. These receiving modes start slightly earlier than the time slots starts T11, T12, T13, T14, T15, etc.

When the data D10 is received in the receiving mode R1A, when the data D20 is received in the receiving mode R2A, when the data D30 is received in the receiving mode R3A, and when the data D40 is received in the receiving mode R4A (in other words, when the CPU 11 of each controller determines that it receives data which includes the ID code corresponding to the controller and a communication command), the CPU 11 immediately releases the receiving mode. Therefore, the receiving modes R1A, R2A, R3A, and R4A are shorter than one time slot (T1).

When the controllers receive the data D10, D20, D30, and D40, the controllers send ACK (acknowledge) signals ACK10, ACK20, ACK30, and ACK40, respectively, which report that the data has been received, to the transmitting and receiving processing section 3 in the time slots when the data is received. Each ACK signal includes an individual controller ID code and an operation signal generated when the operation section 9 is operated.

In the two time slots which include a communication period TM for communication between the transmitting and receiving processing section 3 and the machine body 1, the transmitting and receiving processing section 3 outputs dummy signals DM. The controller CT10 is configured to enter a receiving mode RM1 which is the same as the receiving mode R1A at a time T11 (or slightly earlier than this), the controller CT20 is configured to enter a receiving mode RM2 at a time T12, the controller CT30 is configured to enter a receiving mode RM3 at a time T13, and the controller CT40 is configured to enter a receiving mode RM4 at a time T14.

The controller CT10 receives a dummy signal from the transmitting and receiving processing section 3 at the time T11. When the controller CT10 finishes receiving the dummy signal DM, it immediately releases the receiving mode RM1. Therefore, the receiving mode RM1 is shorter than one time slot T1. Since the controller CT10 has received the dummy signal DM and has not received the ID code or a communication command, it does not send the ACK signal and again sets the receiving mode RM1 at the time T12 of the next time slot.

The controller CT10 also receives a dummy signal at the time T12, but does not send an ACK signal. The controller CT10 operates so as to set the receiving mode R1A at the start time T13 (or slightly earlier than that) of the next time slot. When the controller CT10 receives a signal which includes the ID code and a communication command in the receiving mode R1A, it sends a signal ACK10 which includes an operation signal to the transmitting and receiving processing section 3. After that, a receiving mode is not set for one frame until the next turn of the receiving-mode comes.

The controller CT20 enters the receiving mode RM2 at the time T12, and receives a dummy signal. The controller CT20 does not send an ACK signal and sets a receiving mode for the next time slot. The controller CT20 receives the data D10, not a dummy signal, at the time T13 of the next time slot. Since the data D10 includes the ID code corresponding to the controller CT10 and is not a signal for the controller CT20, the controller 20 again does not send an ACK signal and sets a receiving mode for the next time slot. When the controller CT20 receives the data D20, which includes the ID code corresponding to the controller CT20 and a communication command, in the receiving mode R2A at the time T14, the controller CT20 sends ACK20 to the transmitting and receiving processing section 3.

The controllers CT30 and CT40 are configured to enter receiving modes at the times T13 and T14. Since they receive signals for other controllers at those times, they do not send an ACK signal and set receiving modes for the next time slots. When they receive the data D30 and D40, respectively, which includes the ID codes corresponding to the controllers and a communication command, they each send ACK signals.

FIG. 4 is another timing chart of data transmission and receiving performed between each controller and the transmitting and receiving processing section 3.

In FIG. 4, a communication period TM for communication between the transmitting and receiving processing section 3 and the machine body 1 is completed within one time slot. Therefore, the transmitting and receiving processing section 3 sends a dummy signal at each of the times T11 and T21.

The controller CT10 is configured to enter the receiving mode RM1 at the time T11. Since the controller CT10 receives a dummy signal DM, it does not send an ACK signal and sets a receiving mode for the next time slot. When the controller CT10 receives the data D10 in the receiving mode R1A set at the time T12, it sends signal ACK10, which includes an operation signal, to the transmitting and receiving processing section 3. The controller CT20 receives the data D10, sent to another controller, in the receiving mode RM2 set at the time T12. The controller CT20 does not send an ACK signal, but sets the receiving mode R2A at the time T13 of the next time slot. Since the controller CT20 receives the data D20 at the time T13, it sends a signal ACK20, which includes an operation signal.

In the case shown in FIG. 4, communication is not performed between the transmitting and receiving processing section 3 and the machine body 1 at a time T20, but the data D10 is sent. A communication period TM is inserted between data-D10 transmission and data-D20 transmission.

In this case, the controller CT10 receives the data D10 in the receiving mode R1A at the time T20, and it sends signal ACK10, which includes an operation signal, to the transmitting and receiving processing section 3. The controller CT20 receives a dummy signal in the receiving mode RM2 set in the controller CT20 at a time T21. Therefore, the controller CT20 does not send an ACK signal, but operates so as to set the receiving mode R2A for the next time slot. Then, the controller CT20 receives the data D20 in the receiving mode R2A, and sends the ACK signal 20.

As described above, each controller sequentially sets a receiving mode in a time slot, and when it receives data other than that including its own ID code and a communication command, it does not send an acknowledgement to the transmitting and receiving processing section 3, but operates so as to set a receiving mode for the next time slot. When it receives a signal which includes its own ID code and a communication command, it sends an operation signal to the transmitting and receiving processing section 3 and waits for the next receiving turn.

With such a control, each controller always communicates with the transmitting and receiving processing section 3, and performs an operation while checking an operation routine. In addition, since the receiving mode is not set for an extended period, the load of the CPU 11 caused by the receiving mode is reduced, and power consumption is thereby reduced. Even when the communication period TM for communication between the transmitting and receiving processing section 3 and the machine body 1 extends into a plurality of time slots as shown in FIG. 3, or when the communication period TM is within one time slot as shown in FIG. 4, central malfunctions do not occur. Furthermore, even when the communication period is inserted between the data-D10 transmission and the data-D20 transmission, as shown at the time T21 in FIG. 4, control is correctly performed.

What is claimed is:

1. A data transmitting and receiving apparatus comprising a terminal apparatus having an operation section, and a transmitting and receiving processing section for receiving an operation signal sent from the terminal apparatus by radio, and for sending data to a host section,
wherein the transmitting and receiving processing section comprises a control section for sending a dummy signal to the terminal apparatus at an interval having a predetermined time during a busy period when processing for sending data to the host section is performed, and for sending a communication command to the terminal apparatus at the interval in a period other than the busy period, and
wherein the terminal apparatus comprises a receiving section for which a receiving mode is set for a period shorter than the interval in each interval, and a terminal control section for sending an operation signal to the transmitting and receiving processing section when the communication command is received in the receiving mode, and for controlling so as not to send the operation signal when the dummy signal is received in the receiving mode.

2. A data transmitting and receiving apparatus according to claim 1, wherein the transmitting and receiving processing section is provided with N terminal apparatuses (N is an integer equal to two or more), and
wherein the control section of the transmitting and receiving processing section performs control such that it sequentially sends the communication command to each terminal apparatus at the interval during a period other than the busy period, and it sends a dummy signal at the interval and then sequentially sends a communication command after the dummy signal is sent, during the busy period.

3. A data transmitting and receiving apparatus according to claim 2, wherein a receiving mode is sequentially set for each terminal for a period shorter than the interval in each interval, and when each terminal receives the communication command in the receiving mode, it sends the operation signal to the transmitting and receiving processing section, and
when each terminal receives the dummy signal or data sent to another terminal in the receiving mode, it does not send an operation signal to the transmitting and receiving processing section, but operates so as to set the receiving mode in the next interval.

4. A data transmitting and receiving apparatus according to claim 2, wherein, when the busy period has n intervals (n is an integer equal to one or more), the transmitting and receiving processing section issues a dummy signal n times in n intervals, and then sequentially sends the communication command to each terminal apparatus.

5. A data transmitting and receiving apparatus according to claim 2, wherein, when a period in which the communication command is sequentially sent to a first terminal apparatus to an N-th terminal apparatus is called one frame, the control section of the transmitting and receiving processing section has at least one frame between the busy period and the next busy period.

6. A data transmitting and receiving apparatus according to claim 2, wherein, when a period in which the communication command is sequentially sent to a first terminal apparatus to an N-th terminal apparatus is called one frame, the transmitting and receiving processing section has the busy period inserted into the frame.
